(19) United States
(12) Patent Application Publication
(10) Pub. No.: US 2022/0371363 A1
(43) Pub. Date: Nov. 24, 2022

(54) VEHICLE WHEELS AND METHODS OF MAKING VEHICLE WHEELS

(71) Applicant: Howmet Aerospace Inc., Pittsburgh, PA (US)

(72) Inventor: Spencer Wallace, Broadview Heights, OH (US)

(21) Appl. No.: 17/755,360

(22) PCT Filed: Dec. 8, 2020
(86) PCT No.: PCT/US2020/063757

§ 371 Date: Apr. 27, 2022

Related U.S. Application Data
(60) Provisional application No. 62/945,703, filed on Dec. 9, 2019.

(51) Int. Cl. B60B 21/10; B21D 53/26

(52) U.S. Cl. CPC B60B 21/106; B21D 53/26; B60B 2360/104; B60B 3/02

(57) ABSTRACT

Vehicle wheels and methods of making vehicle wheels are provided. The vehicle wheel comprises a generally annular first region, a second region, and a flange region. The first region comprises an outer surface, an inner surface, a first end, and a second end. The second region extends radially inwardly from the first region, and the second region is configured to mount to a vehicle axle. The flange region extends from the first region. The flange region comprises a first flange end adjacent to the first end of the first region, a second flange end, and a curved elongate portion extending intermediate the first flange end and the second flange end. The curved elongate portion comprises a first thickness no greater than 0.3 inches and a second thickness greater than 0.3 inches.

### FIELD OF USE

The present disclosure relates to vehicle wheels and methods of making vehicle wheels.

### BACKGROUND

Vehicle wheels comprising undesired mass distributions can causes vibrations and/or poor fuel mileage during operation of a vehicle. To correct the undesired mass distributions, wheel weights can be added to regions of the vehicle wheels in order to balance the vehicle wheels. Additionally, the mass of the vehicle wheels can affect the fuel mileage of the vehicle. Designing vehicle wheels to accept wheel weights and achieve desirable fuel mileage of a vehicle presents challenges.

### SUMMARY

According to one aspect of the present disclosure, a vehicle wheel is provided. The vehicle wheel comprises a generally annular first region, a second region, and a flange region. The first region comprises an outer surface, an inner surface, a first end, and a second end. The second region extends radially inwardly from the first region, and the second region is configured to mount to a vehicle axle. The flange region extends from the first region. The flange region comprises a first flange end adjacent to the first end of the first region, a second flange end, and a curved elongate portion extending intermediate the first flange end and the second flange end. The curved elongate portion comprises a first thickness no greater than 0.3 inches and a second thickness greater than 0.3. The vehicle wheel comprises aluminum or an aluminum alloy.

According to another aspect of the present disclosure, a vehicle wheel is provided. The vehicle wheel comprises a generally annular first region, a second region, a first flange region, and a second flange region. The first region comprises an outer surface, an inner surface, a first end, and a second end. The second region extends radially inwardly from the first region adjacent to the first end of the first region. The second region is configured to mount to a vehicle axle. The first flange region extends from the first region. The first flange region comprises a first flange end adjacent to the first end of the first region, a second flange end, and a first curved elongate portion extending intermediate the first flange end and the second flange end. The first curved elongate portion comprises a first thickness no greater than 0.3 inches and a second thickness greater than 0.3 inches. The second flange region extends from the first region, opposite the first flange region. The second flange region comprises a third flange end adjacent to the second end of the first region, a fourth flange end, and a second curved elongate portion extending intermediate the third flange end and the fourth flange end. The second curved elongate portion comprises a third thickness no greater than 0.3 inches and a fourth thickness greater than 0.3 inches. The vehicle wheel comprises aluminum or an aluminum alloy.

According to yet another aspect of the present disclosure, a method of making a vehicle wheel is provided. The method comprises providing a vehicle wheel by a method comprising at least one of forming, curing, forging, casting, and additive manufacturing. The vehicle wheel comprises at least one of metal and a metal alloy. The vehicle wheel comprises a generally annular first region, a second region, and a flange region. The first region comprises an outer surface, an inner surface, a first end, and a second end. The second region extends radially inwardly from the first region, and the second region is configured to mount to a vehicle axle. The flange region extends from the first region. The flange region comprises a first flange end adjacent to the first end of the first region, a second flange end, and a curved elongate portion extending intermediate the first flange end and the second flange end. The curved elongate portion comprises a first thickness no greater than 0.3 inches and a second thickness greater than 0.3 inches. The vehicle wheel comprises aluminum or an aluminum alloy.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a front perspective view of a non-limiting embodiment of a vehicle wheel according to the present disclosure;

FIG. 2 is a cross-sectional detail view of a portion of the vehicle wheel of FIG. 1 taken along line 2-2 of FIG. 1;

FIG. 3 is a detail view of area 3 of FIG. 2;

FIG. 4 is a detail view of area 4 of FIG. 2;

FIG. 5A is a perspective view of a non-limiting embodiment of a wheel weight;

FIG. 5B is a cross-sectional view of the wheel weight of FIG. 5A taken along line 5B-5B of FIG. 5A; and

FIG. 6 is a cross-sectional detailed view of area 4 of the vehicle wheel of FIG. 2 with the wheel weight of FIG. 5A installed thereon.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the example is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

As used herein, a referenced element or region that is “intermediate” two other elements or regions means that the referenced element/region is disposed between, but is not necessarily in contact with, the two other elements/regions. Accordingly, for example, a referenced element that is “intermediate” a first element and a second element may or may not be immediately adjacent to or in contact with the first and/or second elements, and other elements may be disposed between the referenced element and the first and/or second elements.

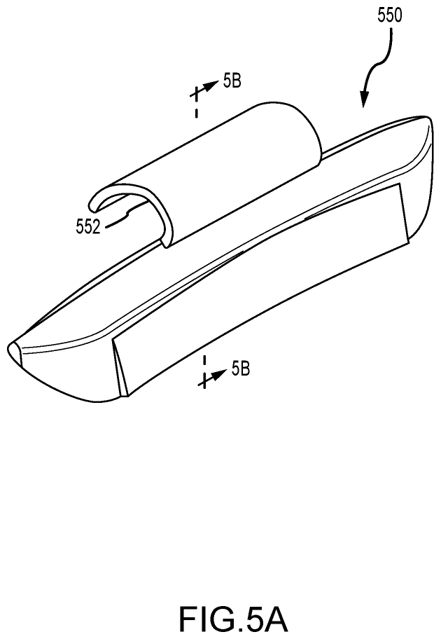

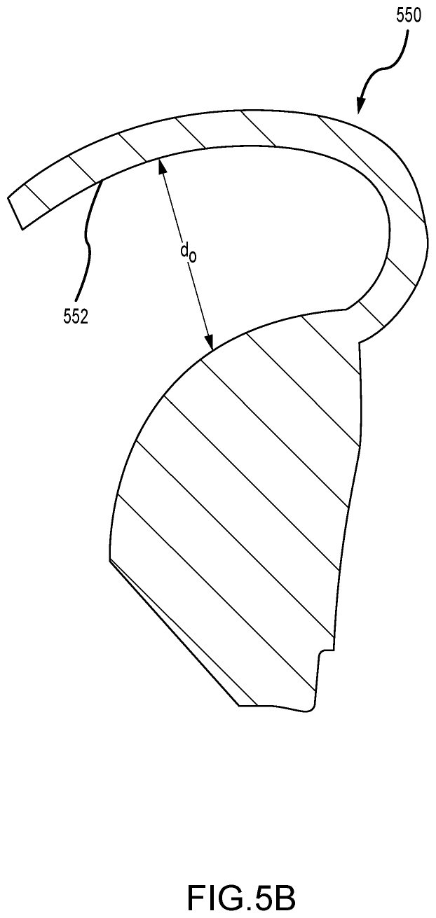

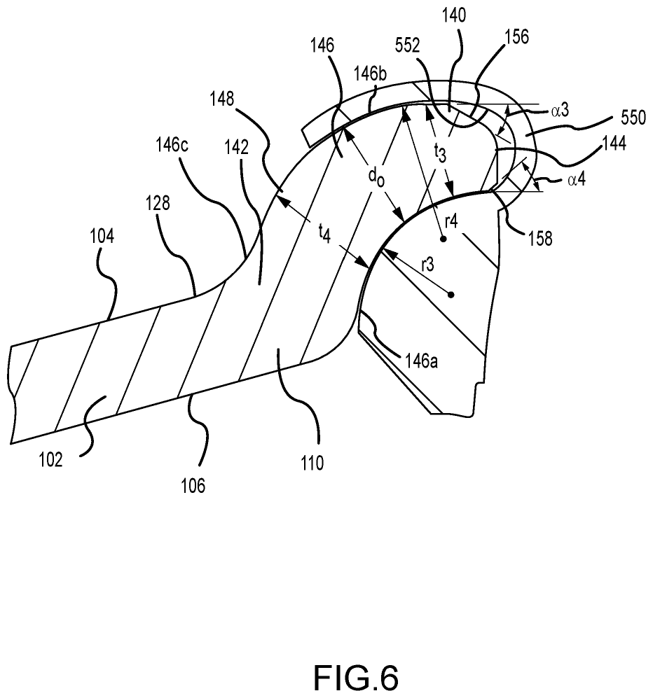

Typically, different wheel weights are used to balance different vehicle wheel types (e.g., sizes, materials). For example, a wheel weight used to balance a steel vehicle wheel may be different than a wheel weight used to balance an aluminum vehicle wheel. Stocking multiple varieties of wheels weights can be costly, and determining which of the variety of wheel weights to use on a particular vehicle wheel can be time consuming. Additionally, the inventors of the present disclosure discovered the flange regions of vehicle wheels can be susceptible to gutter cracks and wear that can result in a failure of the vehicle wheel or a tire mounted to the vehicle wheel. Accordingly, vehicle wheels and methods of making vehicle wheels are provided herein that can include a mounting feature accepting a wheel weight common to various types and/or sizes of wheels (e.g., an I7 series wheel weight 550 as illustrated in FIGS. 5A-5B), reduce the occurrence of gutter cracks, and/or reduce the occurrence of wear to flange regions of the wheel. For example, the I7 series wheel weight 550 can be installed on the vehicle wheel according to the present disclosure as shown in FIG. 6, described below.

Additionally, a sturdy vehicle wheel can be heavy, which can reduce vehicle mileage and increase vehicle fuel costs. According to the present disclosure, a vehicle wheel is provided that can comprise a sturdy structure suitable to support a load carried by the vehicle and which has a decreased mass relative to certain conventional vehicle wheels. The decreased mass can result in fuel savings while operating the vehicle.

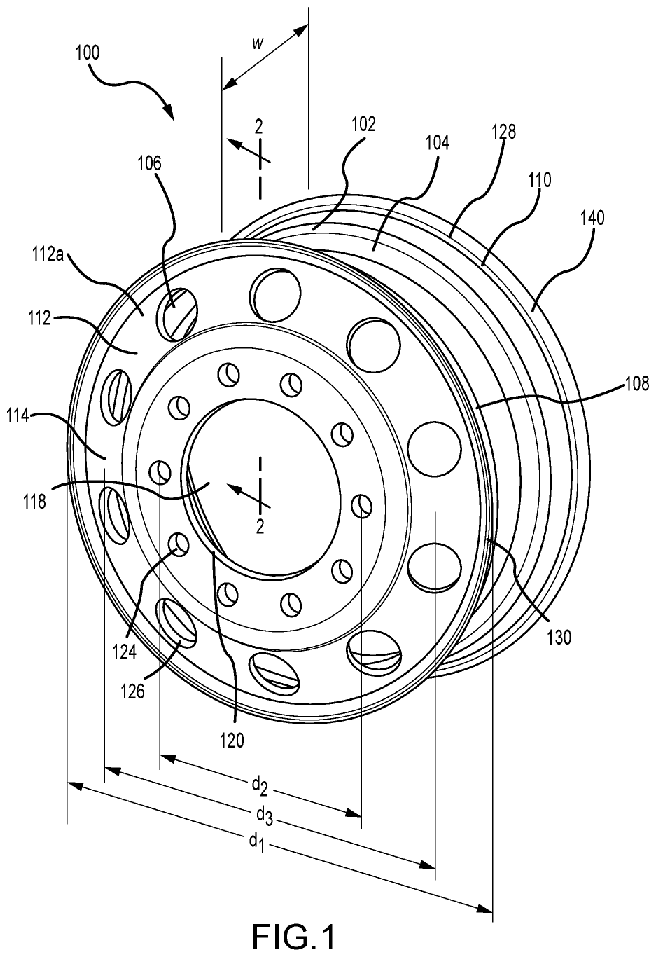

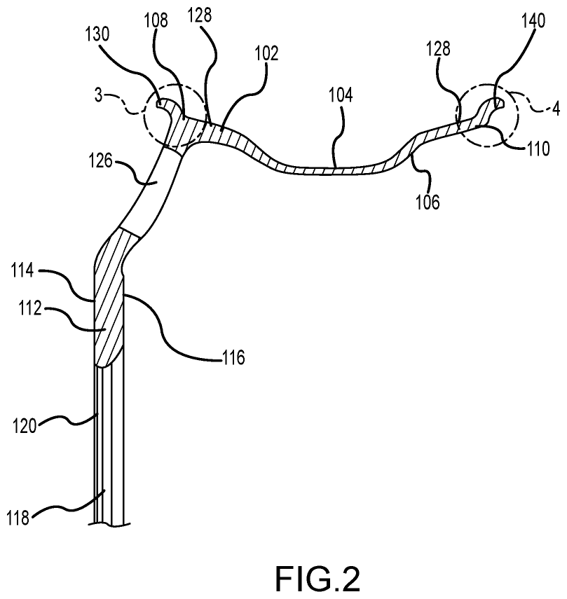

FIGS. 1-4 illustrate a non-limiting embodiment of a vehicle wheel according to the present disclosure. The vehicle wheel 100 comprises a first region 102, a second region 112, a flange region 130, and a flange region 140. The first region 102 can be generally annular and can comprise an outer surface 104, an inner surface 106, a first end 108, and a second end 110. The outer surface 104 can comprise a tire mount 128, which can be disposed about a circumference of the outer surface 104 of the first region 102. The tire mount 128 can be configured so that a tire can be mounted thereon. For example, the tire mount 128 can, as shown, comprise a tire bead set configured to receive a tire. The tire can comprise any suitable dimensions for mounting on the tire mount 128. For example, depending on the dimensions of the tire mount 128, the tire can comprise dimensions of 11R22.5, 295/75R22.5, 11R24.5, 285/75R24.5, or other suitable dimensions.

The first region 102 can comprise a nominal rim width and a nominal rim diameter adapted to receive a tire. In various non-limiting embodiments, the first region 102 can comprise a nominal rim width, w, in a range of 1 inch (2.54 mm) to 100 inches (2540 mm), such as, for example, 6 inches (152.4 mm) to 24 inches (609.6 mm), or 6 inches (152.4 mm) to 12 inches (304.8 mm). For example, and without limitation, in certain non-limiting embodiments, the nominal rim width, w, of the first region 102 can be 8.25 inches (209.6 mm) or 11 inches (279.4 mm).

In various non-limiting embodiments, the first region 102 can comprise a nominal rim diameter, d¹, in a range of 1 inch (2.54 mm) to 200 inches (5080 mm), such as, for example, 14 inches (406.4 mm) to 25 inches (635 mm), or 19 inches (482.6 mm) to 25 inches (635 mm). For example, and without limitation, in certain non-limiting embodiments, the nominal rim diameter, d₁, of the first region 102 can be 22.5 inches (571.5 mm) or 24.5 inches (622.3 mm).

In various embodiments, the first region 102 can comprise a valve stem mount (not shown). The valve stem mount can be configured to receive a valve stem in order to control gas transport into and out of a tire mounted on the tire mount 128.

The second region 112 can extend radially inwardly from the first region 102. In certain non-limiting embodiments, the second region 112 is integral with and extends radially inwardly from the inner surface 106 of the first region 102. In various non-limiting embodiments, the second region 112 extends in a direction that is substantially perpendicular to the inner surface 106 of the first region 102. The second region 112 can comprise a first surface 114, a second surface 116, and an opening 118 extending from the first surface 114 to the second surface 116.

The second region 112 can be configured to mount to a vehicle axle (not shown). For example, the opening 118 can be configured to receive at least a portion of a hub of the vehicle axle. Additionally, a hub surface 120 of the second region 112 can be configured to engage the hub of the vehicle axle and facilitate alignment of the vehicle wheel 100 with the hub of the vehicle axle. In various non-limiting embodiments, the hub surface 120 can comprise a pilot bore suitable to engage a pilot tab of the hub of the vehicle axle.

In various non-limiting embodiments, the second region 112 can comprise at least two bores 124 extending from the first surface 114 to the second surface 116. Each of the at least two bores 124 can be configured to receive a stud on a hub of a vehicle axle. Center points of each of bores 124 can be disposed evenly about a mounting circle. In various non-limiting embodiments, the mounting circle has a center common with the second region 112. In various non-limiting embodiments, the mounting circle can comprise a diameter, d₂, in a range of 1 inch (25.4 mm) to 15 inches (381 mm). For example, the diameter, d₂, can be 11.25 inches (285.75 mm). In various non-limiting embodiments, each bore 124 can have a diameter in a range of 0.1 inches (2.54 mm) to 2 inches (50.8 mm). For example, each bore 124 can have a diameter of 1.023 inches (26 mm). In various non-limiting embodiments, the second region 112 can comprise ten bores 124.

In various non-limiting embodiments, the second region 112 can comprise at least two peripheral openings 126 disposed about a periphery 112a of the second region 112 and proximal to the first region 102. The at least two peripheral openings 126 can reduce a weight of the vehicle wheel 100. In various non-limiting embodiments, the second region 112 can comprise ten peripheral openings 126. In various non-limiting embodiments, the peripheral openings 126 can be disposed about the second region 112 offset from the bores 124, as illustrated in FIG. 1, or can be disposed about the second region 112 substantially in line with the bores 124 (not shown). An offset disposition of the bores 124 and the peripheral openings 126, such as is shown in FIG. 1, can increase a load rating of the vehicle wheel 100. In various non-limiting embodiments, each peripheral opening 126 can be disposed evenly about a peripheral circle. In various non-limiting embodiments, the peripheral circle has a center common with the second region 112. The peripheral circle, for example, can comprise a diameter, d₃, in a range of 2 inches (50.8 mm) to 22 inches (558.8 mm). For example, the diameter, d₃, can be 17.3 inches (439.42 mm).

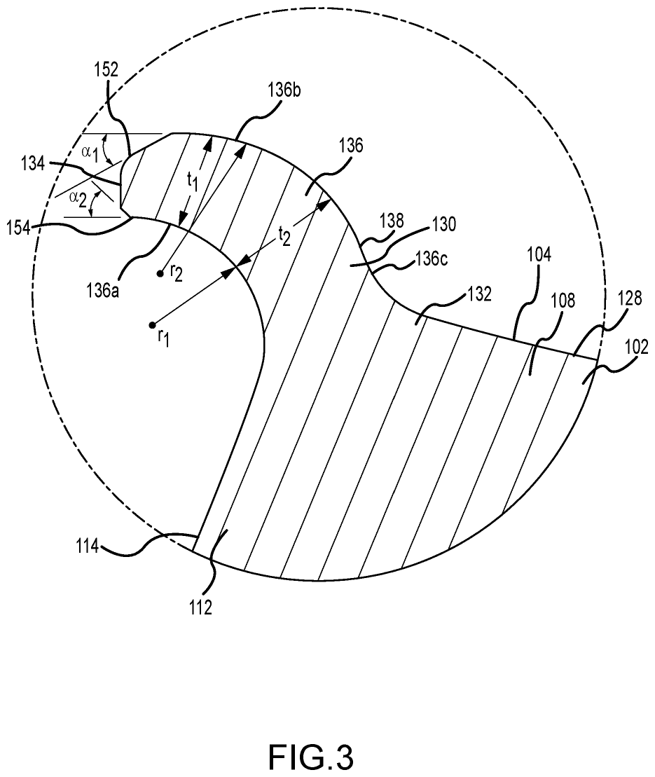

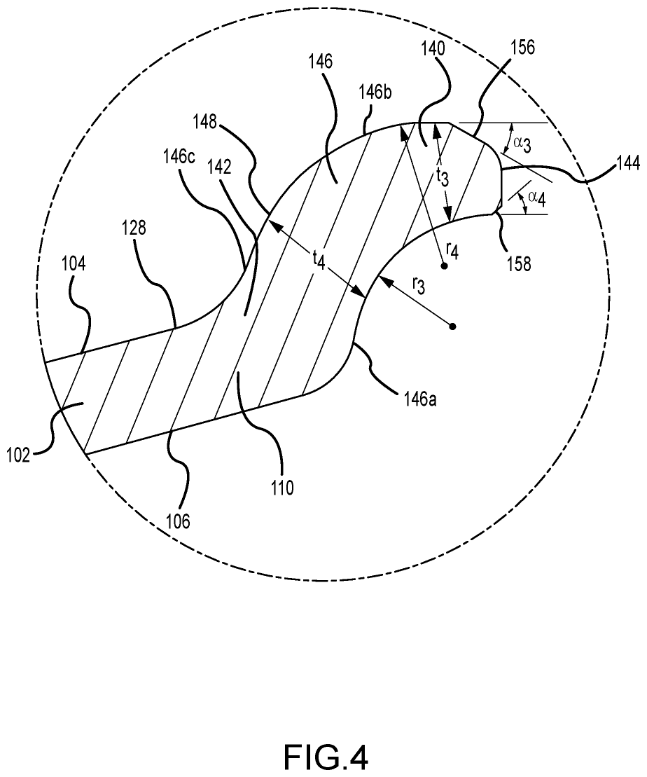

Referring to FIG. 3, the flange region 130 can extend from the first region 102. The flange region 130 can comprise a first flange end 132 adjacent to the first end 108 of the first region 102, a second flange end 134, and a curved elongate portion 136 extending intermediate the first flange end 132 and the second flange end 134. Similarly, referring to FIG. 4, the flange region 140 can extend from the first region 102 opposite the first flange region 130. The flange region 140 can comprise a first flange end 142 adjacent to the second end 110 of the first region 102, a second flange end 144, and a curved elongate portion 146 extending intermediate the first flange end 142 and the second flange end 144. In various non-limiting embodiments, the flange region 140 can be a mirror image of the flange region 130. In certain non-limiting embodiments, the flange regions 130 and 140 are configured to receive and engage a wheel weight (e.g., a clip-on wheel weight), such as, for example, an I7 series wheel weight as illustrated in FIGS. 5A-5B and as described below with reference to FIG. 6.

Referring again to FIG. 3, in certain non-limiting embodiments of vehicle wheel 100 the curved elongate portion 136 can comprise an inner curved surface 136a comprising an inner radius of curvature, r₁, and a first outer curved surface 136b comprising an outer radius of curvature, r₂. Each radius of curvature, r₁ and r₂, can have the same center or different centers. For example, as shown in FIG. 3, when the radii of curvature, r₁ and r₂, have different centers (as represented by dots), the thickness of the curved elongate portion 136 can vary along its. In certain non-limiting embodiments, as shown in FIG. 3, the center of the outer radius of curvature, r₂, can be closer to inner curved surface 136a than the center of the inner radius of curvature, r₁. In various non-limiting embodiments, the thickness of the curved elongate portion 136 can decrease (e.g., taper) as one moves away from the first region 102. The first outer curved surface 136b can extend a first distance and the inner curved surface 136a can extend a second distance greater than the first distance.

Similarly, referring to FIG. 4, in certain non-limiting embodiments of vehicle wheel 100 the curved elongate portion 146 can comprise an inner curved surface 146a comprising an inner radius of curvature, r₃, and a first outer curved surface 146b comprising an outer radius of curvature, r₄. Each radius of curvature, r₃ and r₄, can have the same center or different centers. For example, as shown in FIG. 4, when the radii of curvature, r₃ and r₄, have different centers (as represented by dots), the thickness of the curved elongate portion 146 can vary along its length. In certain embodiments, as shown in FIG. 4, the center of the outer radius of curvature, r₄, can be closer to inner curved surface 146a than the center of the inner radius of curvature, r₃. In various embodiments, the thickness of the curved elongate portion 146 can decrease (e.g., taper) as one moves away from the first region 102. The first outer curved surface 146b can extend a third distance, and the inner curved surface 146a can extend a fourth distance greater than the third distance.

The inner radii of curvature, r₁ and r₃, can be at least 0.3 inches (7.62 mm), such as, for example, at least 0.35 inches (8.89 mm) or at least 0.4 inches (10.16 mm). In various non-limiting embodiments, the inner radii of curvature, r₁ and r₃, can be no greater than 0.5 inches (12.7 mm), such as, for example, no greater than 0.4 inches (10.16 mm) or no greater than 0.35 inches (8.89 mm). In certain non-limiting embodiments, the inner radii of curvature, r₁ and r₃, can be in a range of 0.3 inches (7.62 mm) to 0.5 inches (12.7 mm), such as, for example, in a range of 0.35 inches (8.89 mm) to 0.4 inches (10.16 mm).

The outer radii of curvature, r₂ and r₄, can be at least 0.4 inches (10.16 mm), such as, for example, at least 0.45 inches (11.43 mm) or at least 0.5 inches (12.7 mm). In various non-limiting embodiments, the outer radii of curvature, r₂ and r₄, can be no greater than 0.6 inches (15.24 mm), such as, for example, no greater than 0.5 inches (12.7 mm) or no greater than 0.45 inches (11.43 mm). In certain non-limiting embodiments, the outer radii of curvature, r₂ and r₄, can be in a range of 0.4 inches (10.16 mm) to 0.6 inches (15.24 mm), such as, for example, in a range of 0.45 inches (11.43 mm) to 0.6 inches (15.24 mm). In various non-limiting embodiments, the outer radius of curvature, r₂, can be greater than the inner radius of curvature, r₁, and the outer radius of curvature, r₄, can be greater than the inner radius of curvature, r₃.

As discussed herein, the thickness of the curved elongate portions 136 and 146 can vary along their lengths. Referring to FIGS. 3 and 4, the curved elongate portion 136 can comprise thicknesses, t₁ and t₂, which can be different, and the curved elongate portion 146 can comprise thicknesses, t₃ and t₄, which can be different. The thickness t₁ can extend a first distance along the curved elongate portion 136 and the thickness t₂ can extend a second distance along the curved elongate portion 136. The first and second distances can be the same or different. The thickness t₃ can extend a third distance along the curved elongate portion 146 and the thickness t₄ can extend a fourth distance along the curved elongate portion 146. The third and fourth distances can be the same or different. The first and third distances can be substantially the same or different and the second and fourth distances can be substantially the same or different. The first distance and second distance can be sized and configured to enable a wheel weight to be received by the respective flange portion 130 or 140. The second distance and fourth distance can be sized and configured such that the respective flange portion 130 and 140 can engage a wheel weight with a desired amount of contact area.

The thicknesses, t₁ and t₃, can be no greater than 0.3 inches (7.62 mm), such as, for example, no greater than 0.25 inches (6.35 mm), no greater than 0.2 inches (5.08 mm), or no greater than 0.1 inches (2.54 mm). In various non-limiting embodiments, the thicknesses, t¹ and t₃, can be at least 0.05 inches (1.27 mm), such as, for example, at least 0.1 inches (2.54 mm), at least 0.2 inches (5.08 mm), or at least 0.25 inches (6.35 mm). In certain non-limiting embodiments, the thicknesses, t₁ and t₃, can be in a range of 0.05 inches (1.27 mm) to 0.3 inches (7.62 mm), such as for example, 0.1 inches (2.54 mm) to 0.3 inches (7.62 mm).

In various non-limiting embodiments, the thicknesses, t₂ and t₄, can be at least 0.3 inches (7.62 mm), such as, for example, at least 0.35 inches (8.89 mm), at least 0.4 inches (10.16 mm), or at least 0.5 inches (12.7 mm). The thicknesses, t₂ and t₄, can be no greater than 0.7 inches (17.78 mm), such as, for example, no greater than 0.5 inches (12.7 mm), no greater than 0.4 inches (10.16 mm), or no greater than 0.35 inches (8.89 mm). In certain non-limiting embodiments, the thicknesses, t₂ and t₄, can be in a range of greater than 0.03 inches (7.62 mm) to 0.7 inches (17.78 mm), such as for example, 0.35 inches (8.89 mm) to 0.5 inches (12.7 mm).

Referring again to FIG. 3, in certain non-limiting embodiments of vehicle wheel 100 the curved elongate portion 136 can comprise a second outer surface 136c intermediate the first outer curved surface 136b and the first end 108 of the first region 102. The first outer curved surface 136b and the second outer surface 136c can meet at an inflection point 138. Referring again to FIG. 4, the curved elongate portion 146 can comprise a second outer curved surface 146c intermediate the first outer curved surface 146b and the second end 110 of the first region 102. The first outer curved surface 146b and the second outer surface 146c can meet at an inflection point 148.

Referring to FIG. 3 yet again, the flange region 130 can comprise a first chamfer 152 and a second chamfer 154. The first chamfer 152 and the second chamfer 154 can each be intermediate the second flange end 134 and the curved elongate portion 136. The first chamfer 152 can be positioned adjacent to the outer curved surface 136b and the second chamfer 154 can be positioned adjacent to the inner curved surface 136a. The first chamfer 152 can define an angle, α₁, and the second chamfer 154 can define an angle, α₂.

Referring again to FIG. 4, in certain non-limiting embodiments of vehicle wheel 100 the flange region 140 can comprise a third chamfer 156 and a fourth chamfer 158. The third chamfer 156 and the fourth chamfer 158 can each be intermediate the second flange end 144 and the curved elongate portion 146. The third chamfer 156 can be positioned adjacent to the outer curved surface 146b and the fourth chamfer 158 can be positioned adjacent to the inner curved surface 146a. The third chamfer 156 can define an angle, α₃, and the fourth chamfer 158 can define an angle, α₄.

In various non-limiting embodiments, each angle, α₁-α₄, can be at least 20 degrees, such as, for example, at least 30 degrees. In various non-limiting embodiments, each angle, α₁-α₄, can be no greater than 40 degrees, such as, for example, no greater than 30 degrees. In certain non-limiting embodiments, each angle, α₁-α₄, can be in a range of 20 degrees to 40 degrees.

Referring to FIGS. 3 and 4, the size and configuration of the flange regions 130 and 140 can affect the mass of the vehicle wheel 100. Thus, the weight of the vehicle wheel 100 can be reduced by decreasing the mass of the flange regions 130 and 140. Additionally, the flange regions 130 and 140 may not be load-bearing portions of the vehicle wheel 100. Therefore, decreasing mass of the flange regions 130 and 140 can reduce the weight of the vehicle wheel 100 while maintaining the load rating of the vehicle wheel 100. In various non-limiting embodiments, reducing mass of the flange regions 130 and 140 can allow the addition of more material/mass to load-bearing bearing portions of the vehicle wheel 100 to increase the load rating of the wheel, while maintaining overall wheel weight such that the fuel economy of the vehicle on which the wheel is mounted can be unchanged.

In various non-limiting embodiments of vehicle wheel 100, flange regions 130 and 140 can be less rigid than a typical vehicle wheel flange region, which can reduce forceful contact between a tire mounted on the vehicle wheel 100 and the flange regions 130 and 140, resulting in a reduction in the formation of gutter cracks and/or reduced wear on the flange regions 130 and 140.

FIGS. 5A-5B show an I7 series wheel weight 550. The I7 series wheel weight 550 can comprise a cupped portion 552 and an opening diameter, dₒ. The opening diameter, dₒ, can be sized and configured to receive the thickness, t₁, of flange region 130 and/or the thickness, t₃, of flange region 140. The opening diameter, dₒ, can be sized and configured to engage the thickness, t₂, of flange region 130 and the thickness, t₄, of flange region 140 such that a clamping force is achieved between the I7 series wheel weight 550 and the respective flange region 130 or 140. For example, the opening diameter, dₒ, can be 0.3 inches. In various non-limiting embodiments, the I7 series wheel weight 550 can weigh 1 ounce to 16 ounces.

One or more wheel weights can be installed on the vehicle wheel according to the present disclosure. An operator can determine the desired wheel weight for an application by inspecting the flange region 130 or 140 that will receive the wheel weight. For example, referring to FIG. 6, the I7 series wheel weight 550 is shown installed on the vehicle wheel 100. The operator can determine an imbalanced point on the vehicle wheel 100 and position the cup portion 552 of the wheel weight 550 over the respective flange region 130 and 140 at that point. As illustrated in FIG. 6, the I7 series wheel weight 550 was positioned over flange region 140. Thereafter, the operator may apply a force to the I7 series wheel weight 550 to urge the cupped portion 552 to at least partially contact the flange region 140 and engage the thickness, t₄. In various embodiments, the vehicle wheels according to the present disclosure can comprise a metal or metal alloy. For example, the vehicle wheel according to the present disclosure can comprise at least one of aluminum, an aluminum alloy, titanium, a titanium alloy, magnesium, a magnesium alloy, iron, and an iron alloy. In various embodiments, the vehicle wheel can comprise aluminum or an aluminum alloy.

In various embodiments, vehicle wheels according to the present disclosure can be, for example, at least one of a bonded wheel, a welded wheel, a formed wheel (e.g., vacuum formed), a cured wheel, a cast wheel, a forged wheel, and an additively manufactured wheel. For example, the vehicle wheels according to the present disclosure can be forged wheels. In various embodiments, the flanged portions of the vehicle wheel are not formed by rolling. For example, the flanged portions of the vehicle wheels can be formed by forging. The vehicle wheels according to the present disclosure may have been subjected to further processing to provide the final vehicle wheel, such as, for example, a lathe procedure.

In various non-limiting embodiments, the vehicle wheels according to the present disclosure can weigh at least 10 pounds (lbs.) (4.5 kg), such as, for example, at least 25 lbs. (11.3 kg), at least 35 lbs. (15.9 kg), or at least 40 lbs. (18.1 kg). In some embodiments, the vehicle wheels according to the present disclosure can weigh no greater than 50 lbs. (22.7 kg), such as, for example, no greater than 40 lbs. (18.1 kg), no greater than 35 lbs. (15.9 kg), no greater than 25 lbs. (11.3 kg), or no greater than 10 lbs. (4.5 kg). In some embodiments, the vehicle wheels according to the present disclosure can weigh in a range of 10 lbs. (4.5 kg) to 50 lbs. (22.7 kg), such as, for example, 25 lbs. (11.3 kg) to 40 lbs. (18.1 kg).

In various non-limiting embodiments, the load rating of vehicle wheels according to the present disclosure can be at least 1,000 pounds (lbs.) (453.6 kg), such as, for example, at least 5,000 lbs. (2268 kg), at least 9,000 lbs. (4082.3 kg), at least 10,000 lbs. (4535.92 kg), at least 13,000 lbs. (5896.7 kg), or at least 15,000 lbs. (6803.89 kg). In various non-limiting embodiments, the load rating of vehicle wheels according to the present disclosure can be no greater than 20,000 lbs. (9071.85 kg), such as, for example, no greater than 15,000 lbs. (6803.89 kg), no greater than 13,000 lbs. (5896.7 kg), no greater than 10,000 lbs. (4535.92 kg), no greater than 9,000 lbs. (4082.3 kg), or no greater than 5,000 lbs. (2268 kg). In various non-limiting embodiments, the load rating of vehicle wheels according to the present disclosure can be 1,000 lbs. (453.6 kg) to 20,000 lbs. (9071.85 kg), such as, for example, 5,000 lbs. (2268 kg) to 15,000 lbs. (6803.89 kg) or 9,000 lbs. (4082.3 kg) to 13,000 lbs. (5896.7 kg). In various embodiments, the load rating of vehicle wheels according to the present disclosure can be at least 10,000 lbs. (4535.92 kg) and the vehicle wheel can weigh less than 40 lbs. (18.1 kg).

A method for using a vehicle wheel according to the present disclosure is provided. The method comprises mounting a vehicle wheel according to the present disclosure on a steer axle of a vehicle, a drive axle of a vehicle, or a trailer axle of a trailer. The vehicle can comprise a vehicle weight class in a range of 1 to 8, such as, for example, 3 to 8, as defined by the U.S. Federal Highway Administration. For example, in various non-limiting embodiments the gross weight of the vehicle can be at least 10,001 lbs. (4536.48 kg) or at least 26,000 lbs. (11,798.4 kg). The vehicle can be, for example, a light-duty, medium-duty, or heavy-duty vehicle, such as, for example, a medium-duty or heavy-duty vehicle. In various non-limiting embodiments, the vehicle can be a truck (e.g., pick-up, full-sized, tractor (e.g., semi-truck)), a van, or a bus. The vehicle can comprise at least two axles, such as, for example, at least three axles, at least four axles, at least five axles, or at least six axles. In various non-limiting embodiments, the vehicle can comprise no greater than ten axles such as, for example, no greater than six axles, no greater than five axles, no greater than four axles, or no greater than three axles. In various non-limiting embodiments, the vehicle can comprise a quantity of axles in a range of two to ten.

The trailer can comprise a single axle or at least two axles, such as, for example, at least three axles, at least four axles, at least five axles, or at least six axles. In various non-limiting embodiments, the trailer can comprise no greater than ten axles, such as, for example, no greater than six axles, no greater than five axles, no greater than four axles, or no greater than three axles. In various non-limiting embodiments, the trailer can comprise one to ten axles.

A method of producing a vehicle wheel according to the present disclosure also is provided. The method comprises forming, curing, forging, casting, and/or additively manufacturing at least one of a metal and a metal alloy to provide a vehicle wheel according to the present disclosure. In various embodiments, the method of making the vehicle wheel comprises steps in addition to the forming, curing, casting, forging, or additive manufacturing. For example, the flange regions of the vehicle wheels can be formed utilizing a lathe. Creating the flange regions with a geometry suitable to be formed on a lathe can enable rapid manufacture of the vehicle wheels.

Various aspects of the invention include, but are not limited to, the aspects listed in the following numbered clauses.

1. A vehicle wheel comprising:
a generally annular first region comprising an outer surface, an inner surface, a first end, and a second end;
a second region extending radially inwardly from the first region, the second region configured to mount to a vehicle axle; and
a flange region extending from the first region, the flange region comprising a first flange end adjacent to the first end of the first region, a second flange end, and a curved elongate portion extending intermediate the first flange end and the second flange end, wherein the curved elongate portion comprises a first thickness no greater than 0.3 inches and a second thickness greater than 0.3 inches,
wherein the vehicle wheel comprises aluminum or an aluminum alloy.
   2. The vehicle wheel of clause 1, wherein a thickness of the curved elongate portion varies along a length of the curved elongate portion.
   3. The vehicle wheel of any one of clauses 1-2, wherein the curved elongate portion comprises an inner curved surface comprising an inner radius of curvature in a range of 0.3 to 0.5 inches.
   4. The vehicle wheel of any one of clauses 1-3, wherein the curved elongate portion comprises a first outer curved surface comprising an outer radius of curvature in a range of 0.4 to 0.6 inches.
   5. The vehicle wheel of clause 4, wherein the curved elongate portion comprises a second outer surface intermediate the first outer curved surface and the first end of the first region.
   6. The vehicle wheel of clause 5, wherein the first outer curved surface and second outer surface meet at an inflection point.
   7. The vehicle wheel of any one of clauses 1-6, wherein the first outer curved surface extends a first distance and the inner curved surface extends a second distance greater than the first distance.
   8. The vehicle wheel of any one of clauses 1-7, further comprising a first chamfer intermediate the second flange end and the elongate portion.
   9. The vehicle wheel of clause 8, wherein the first chamfer defines an angle in a range of 20 degrees to 40 degrees.
   10. The vehicle wheel of any one of clauses 8-9, further comprising a second chamfer intermediate the second flange end and the elongate portion.
   11. The vehicle wheel of any one of clauses 1-10, further comprising a second flange region extending from the first region, opposite the first flange region, the second flange region comprising a third flange end adjacent to the second end of the first region, a fourth flange end, and a second curved elongate portion extending intermediate the third flange end and the fourth flange end, wherein the second curved elongate portion comprises a third thickness no greater than 0.3 inches and a fourth thickness greater than 0.3 inches.
   12. The vehicle wheel of any one of clauses 1-11, wherein the vehicle wheel comprises at least one of a metal and a metal alloy.
   13. The vehicle wheel of any one of clauses 1-12, wherein the first region comprises a nominal rim diameter in a range of 1 inch to 200 inches, and a nominal rim width in a range of 1 inch to 100 inches.
   14. The vehicle wheel of any one of clauses 1-13, wherein the first region comprises a nominal rim diameter in a range of 19 inches to 24 inches, and a nominal rim width in a range of 6 inches to 24 inches.
   15. A vehicle wheel comprising:
a generally annular first region comprising an outer surface, an inner surface, a first end, and a second end;
a second region extending radially inwardly from the first region adjacent to the first end of the first region, the second region configured to mount to a vehicle axle;
a first flange region extending from the first region, the first flange region comprising a first flange end adjacent to the first end of the first region, a second flange end, and a first curved elongate portion extending intermediate the first flange end and the second flange end, wherein the first curved elongate portion comprises a first thickness no greater than 0.3 inches and a second thickness greater than 0.3 inches; and
a second flange region extending from the first region, opposite the first flange region, the second flange region comprising a third flange end adjacent to the second end of the first region, a fourth flange end, and a second curved elongate portion extending intermediate the third flange end and the fourth flange end, wherein the second curved elongate portion comprises a third thickness no greater than 0.3 inches and a fourth thickness greater than 0.3 inches,
wherein the vehicle wheel comprises aluminum or an aluminum alloy.
   16. The vehicle wheel of clause 15, wherein the first curved elongate portion comprises a first inner curved surface comprising an inner radius of curvature in a range of 0.3 to 0.5 inches, and the second curved elongate portion comprises a second inner curved surface comprising an inner radius of curvature in a range of 0.3 to 0.5 inches.
   17. The vehicle wheel of any one of clauses 15-16, wherein the first curved elongate portion comprises a first outer curved surface comprising an outer radius of curvature in a range of 0.4 to 0.6 inches, and the second curved elongate portion comprises a second outer curved surface comprising an outer radius of curvature in a range of 0.4 to 0.6 inches.
   18. A method of producing a vehicle wheel, the method comprising:

providing a vehicle wheel by a method comprising at least one of forming, curing, forging, casting, and additive manufacturing, the vehicle wheel comprising at least one of metal and a metal alloy, the vehicle wheel comprising:
a generally annular first region comprising an outer surface, an inner surface, a first end, and a second end;
a second region extending radially inwardly from the first region, the second region configured to mount to a vehicle axle; and
a flange region extending from the first region, the flange region comprising a first flange end adjacent to the first end of the first region, a second flange end, and a curved elongate portion extending intermediate the first flange end and the second flange end, wherein the curved elongate portion comprises a first thickness no greater than 0.3 inches and a second thickness greater than 0.3 inches,
wherein the vehicle wheel comprises aluminum or an aluminum alloy.
   19. The method of clause 18, wherein the curved elongate portion comprises an inner curved surface comprising an inner radius of curvature in a range of 0.3 to 0.5 inches.
   20. The method of any one of clauses 18-19, wherein the curved elongate portion comprises an outer curved surface comprising an outer radius of curvature in a range of 0.4 to 0.6 inches.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A vehicle wheel comprising:
a generally annular first region comprising an outer surface, an inner surface, a first end, and a second end;
a second region extending radially inwardly from the first region, the second region configured to mount to a vehicle axle; and
a flange region extending from the first region, the flange region comprising a first flange end adjacent to the first end of the first region, a second flange end, and a curved elongate portion extending intermediate the first flange end and the second flange end, wherein the curved elongate portion comprises a first thickness no greater than 0.3 inches and a second thickness greater than 0.3 inches,
wherein the vehicle wheel comprises aluminum or an aluminum alloy.

2. The vehicle wheel of claim 1, wherein a thickness of the curved elongate portion varies along a length of the curved elongate portion.

3. The vehicle wheel of claim 1, wherein the curved elongate portion comprises an inner curved surface comprising an inner radius of curvature in a range of 0.3 to 0.5 inches.

4. The vehicle wheel of claim 1, wherein the curved elongate portion comprises a first outer curved surface comprising an outer radius of curvature in a range of 0.4 to 0.6 inches.

5. The vehicle wheel of claim 4, wherein the curved elongate portion comprises a second outer surface intermediate the first outer curved surface and the first end of the first region.

6. The vehicle wheel of claim 5, wherein the first outer curved surface and second outer surface meet at an inflection point.

7. The vehicle wheel of claim 1, wherein the first outer curved surface extends a first distance and the inner curved surface extends a second distance greater than the first distance.

8. The vehicle wheel of claim 1, further comprising a first chamfer intermediate the second flange end and the elongate portion.

9. The vehicle wheel of claim 8, wherein the first chamfer defines an angle in a range of 20 degrees to 40 degrees.

10. The vehicle wheel of claim 8, further comprising a second chamfer intermediate the second flange end and the elongate portion.

11. The vehicle wheel of claim 1, further comprising a second flange region extending from the first region, opposite the first flange region, the second flange region comprising a third flange end adjacent to the second end of the first region, a fourth flange end, and a second curved elongate portion extending intermediate the third flange end and the fourth flange end, wherein the second curved elongate portion comprises a third thickness no greater than 0.3 inches and fourth thickness greater than 0.3 inches.

12. The vehicle wheel of claim 1, wherein the vehicle wheel comprises at least one of a metal and a metal alloy.

13. The vehicle wheel of claim 1, wherein the first region comprises a nominal rim diameter in a range of 1 inch to 200 inches, and a nominal rim width in a range of 1 inch to 100 inches.

14. The vehicle wheel of claim 1, wherein the first region comprises a nominal rim diameter in a range of 19 inches to 24 inches, and a nominal rim width in a range of 6 inches to 24 inches.

15. A vehicle wheel comprising:
a generally annular first region comprising an outer surface, an inner surface, a first end, and a second end;
a second region extending radially inwardly from the first region adjacent to the first end of the first region, the second region configured to mount to a vehicle axle;
a first flange region extending from the first region, the first flange region comprising a first flange end adjacent to the first end of the first region, a second flange end, and a first curved elongate portion extending intermediate the first flange end and the second flange end, wherein the first curved elongate portion comprises a first thickness no greater than 0.3 inches and a second thickness greater than 0.3 inches; and
a second flange region extending from the first region, opposite the first flange region, the second flange region comprising a third flange end adjacent to the second end of the first region, a fourth flange end, and a second curved elongate portion extending intermediate the third flange end and the fourth flange end, wherein the second curved elongate portion comprises a third thickness no greater than 0.3 inches and a fourth thickness greater than 0.3 inches,
wherein the vehicle wheel comprises aluminum or an aluminum alloy.

16. The vehicle wheel of claim 15, wherein the first curved elongate portion comprises a first inner curved surface comprising an inner radius of curvature in a range of 0.3 to 0.5 inches, and the second curved elongate portion comprises a second inner curved surface comprising an inner radius of curvature in a range of 0.3 to 0.5 inches.

17. The vehicle wheel of claim 15, wherein the first curved elongate portion comprises a first outer curved surface comprising an outer radius of curvature in a range of 0.4 to 0.6 inches, and the second curved elongate portion comprises a second outer curved surface comprising an outer radius of curvature in a range of 0.4 to 0.6 inches.

18. A method of producing a vehicle wheel, the method comprising:
providing a vehicle wheel by a method comprising at least one of forming, curing, forging, casting, and additive manufacturing, the vehicle wheel comprising at least one of metal and a metal alloy, the vehicle wheel comprising:
a generally annular first region comprising an outer surface, an inner surface, a first end, and a second end;
a second region extending radially inwardly from the first region, the second region configured to mount to a vehicle axle; and
a flange region extending from the first region, the flange region comprising a first flange end adjacent to the first end of the first region, a second flange end, and a curved elongate portion extending intermediate the first flange end and the second flange end, wherein the curved elongate portion comprises a first thickness no greater than 0.3 inches and a second thickness greater than 0.3 inches,
wherein the vehicle wheel comprises aluminum or an aluminum alloy.

19. The method of claim 18, wherein the curved elongate portion comprises an inner curved surface comprising an inner radius of curvature in a range of 0.3 to 0.5 inches.

20. The method of claim 18, wherein the curved elongate portion comprises an outer curved surface comprising an outer radius of curvature in a range of 0.4 to 0.6 inches.
